(19) United States
(12) Patent Application Publication
(10) Pub. No.: US 2017/0046657 A1
(43) Pub. Date: Feb. 16, 2017

(54) GPS Scanner

(71) Applicant: Tina Allen, Killen, AL (US)

(72) Inventor: Tina Allen, Killen, AL (US)

(21) Appl. No.: 14/822,630

(22) Filed: Aug. 10, 2015

(51) Int. Cl. G06Q 10/08

(52) U.S. Cl. CPC G06Q 10/08355; G06Q 10/0833

(57) ABSTRACT

An improved a GPS enabled system integrated with a scanner is disclosed for delivering packages to ensure on time deliveries. The GPS scanner serves as a navigation device that scans the addresses of the packages to be delivered. It also gives the deliverer (or driver) their route for the day from beginning to end, while also taking priority packages into consideration in a sequential manner, thereby providing the route, distance, and time of delivery to each package. The GPS enabled system also asseses real-time congestion of traffic along a route, weather conditions, required information from other peers, information related to a job handover, and/or changes in requests related to deliveries.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention relates to package tracking systems, and, more particularly, to GPS enabled systems for scanning and locating addresses for delivery to ensure on time delivery.

(2) Background of Invention

Package delivery companies, such as the assignee of the present invention, may handle as many as several million packages each day. In order to improve the efficiency and accuracy with which this volume of packages is handled, these companies increasingly rely on automated package sorting and routing facilities. These companies also desire to obtain package related information in order to better manage their operations and to provide a variety of shipping related information to their customers, with on time deliveries.

The process of sorting and tracking packages as they proceed through a package transportation system requires that each package bear two types of information. First, each package must provide a destination address. Second, each package must include a tracking number that uniquely identifies it from other packages in the system.

The destination address is required in order for the package delivery company to know where the package is going. The destination address, which includes alphanumeric text, is typically written on the package or printed on a label that is affixed to the package. For addresses in the United States, the destination address includes a street address, city, state, and zip code.

The tracking number, which consists of a series of alphanumeric characters, uniquely identifies each package in the package transportation system. In most cases, the tracking number is affixed to the package in the form of a machine readable code or symbol, such as a bar code. The machine readable code is read by electronic code readers at various points in the transportation system. This allows the package delivery company to monitor the movement of each package though its system, and to provide customers with information pertaining to the status and location of each package.

To improve the efficiency of last mile delivery, numerous conflicting constraints are involved, e.g., congestion on roads, delivery time requirements for different categories of mail, such as priority post, varying customer needs, real time notification to pick up a packet for upstream while engaged in downstream delivery, and so on. Though a flood of new technologies and services have cropped up in the past years promising to streamline companies supply chains, few solutions have sufficiently addressed the last mile delivery problem. Given the performance efficiency expected by customers versus cost-sensitiveness of the last mile, delivery agencies are quite logically seeking ways to reduce costs, especially at the distribution end.

Thus, there is a need to search for efficient delivery methods, thereby rendering lower delivery costs minimum delivery time, employing a lesser number of carriers, and offering better service to customers.

As such, it may be appreciated that there continues to be a need bra new and improved package delivery system, as set forth by the instant invention that addresses the problems of ease of use as well as effectiveness in construction in providing on time package deliveries. In this respect, the present invention substantially fulfills this need.

### BRIEF SUMMARY OF THE INVENTION

In view of the foregoing disadvantages inherent in the known types of package delivery systems now present in the prior art, the present invention provides a system and device to ensure the on time delivery of packages, wherein the same provides a GPS scanner to locate and track addresses and use the various components employed in the procedure. As such, the general purpose of the present invention, which will be described subsequently in greater detail, is to provide a new and improved system and device for delivering packages that has all of the advantages of the prior art, and none of the disadvantages.

Accordingly, it is a primary objective of the present invention to provide an improved system and device for delivering packages to ensure on time deliveries. For this purpose, a GPS enabled system that is integrated with a scanner is provided.

In another aspect, the present invention provides a GPS scanner to scan the addresses of the packages that are to be delivered. The GPS scanner serves as a navigation device, and, thus, gives the deliverer (or driver) their route for the day from the beginning to the end while also taking priority packages into consideration.

It is yet another aspect of the present invention where the GPS scanner and provided system gives the route, distance, and time of delivery of each package.

Additionally, the GPS enabled system also asseses real-time congestion of traffic along a route, weather conditions, required information from other peers, information related to a job handover, and/or changes in requests related to deliveries.

A further aspect of the present invention provides a light weight and easy to use scanner that is integrated with other technologies, such as google maps, WAZE, google search, etc.

Another aspect provides a downloadable mobile application for smart phones and related devices to allow customers to track the location of their packages.

It is still another objective of the present invention to provide a new and improved GPS enabled package delivery system that may be easily and efficiently manufactured and marketed.

It is a further objective of the present invention to provide a new and GPS enabled package delivery system that is of a durable and reliable construction.

Other aspects of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 depicts a perspective view of the GPS scanner device.

### DETAIL DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of is explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order to not obscure the illustrative embodiments.

As used in this disclosure, ‘services’ includes the pickup and delivery of products (e.g., packages and/or mail), services which do not provide a product, and other related activities. Further examples of “services” include the delivery and pickup of packages, letters, etc., (e.g., UPS, FEDEX, USPS, DHI [e.g., packages and mails]), delivering food products and other personal items, providing car repair and/or towing services, logistic services, and cable television services, to name a few. A “service vehicle” generically refers to any vehicle used to provide services. AS used in this disclosure, “delivery” and “deliverable” may refer to the delivery of services, and does not necessarily require (although includes) delivery of a physical product.

In some preferred embodiments, the present invention provides an improved GPS enabled system that is integrated with a scanner device for delivering packages to ensure on time deliveries. The GPS scanner serves as a navigation device that scans the addresses of the packages that are to be delivered and gives the deliverer (or driver) their route for the day from beginning to end, thereby providing the route, distance and time of delivery to each package.

An optimized geographical route between multiple destinations is determined on scanning the addresses of the packages. According to some embodiments, the optimum route is determined based on static information and dynamic information that has been received wirelessly through the GPS. The route is optimized to enhance distribution efficiency and reduce costs associated with package delivery, while simultaneously reducing use of the wireless network.

According to some embodiments, a deliverer will scan deliverables at a point of origin so as to effectively enter the required information into a system to create the route for the deliverer (or driver) from, e.g., labels of packages or the like. In some embodiments, this information can include, e.g.:
Addressee information (e.g., Name, Phone Number, email address and/or a Proxy's Name, Phone Number, etc., in cases where an addressee is absent);
Delivery Destination information (e.g., Postal Address);
Delivery Requirements (e.g., priority mail, regular, signature required, signature not required/drop at door step, time of delivery, etc.).

According to some embodiments, the GPS enabled system is also made capable of receiving information, such as, e.g.:
Real time traffic congestion information all of the routes that correspond to the entered destinations,
Real time presence information of the addressees/proxies at the addressed destinations; and
Real time feedback received from the addressee/proxy in response to the automatic SMS query pertaining to delivery options (e.g., alternate delivery address requested by the addressee corresponding to his real time present position, alternate time requested by the addressee, care of address, etc.)

In a further embodiment, making use of above noted information, an optimum route planning will be executed in the system that will enable the system to plan and specify an optimized route involving all of the destinations prioritized in a manner that would meet the criteria set by the parameters (listed above). In some embodiments, the output of the GPS enabled delivering system will be informed to the navigation system directly by the GPS scanner. Preferably, the navigation system will guide the deliverer with driving directions (such as, e.g., according to existing state of art global positioning systems (GPS)), thereby enabling him to deliver packages one by one in a sequential manner.

Among other things, because route planning can be done by an electronic server taking into account several variables pertaining to the above listed information, compared to human planning, it would be efficient and, thus, cost effective. Furthermore, since the route planning and navigational computations can be done by the GPS enabled delivering system, it can avoid heavy signaling burdens.

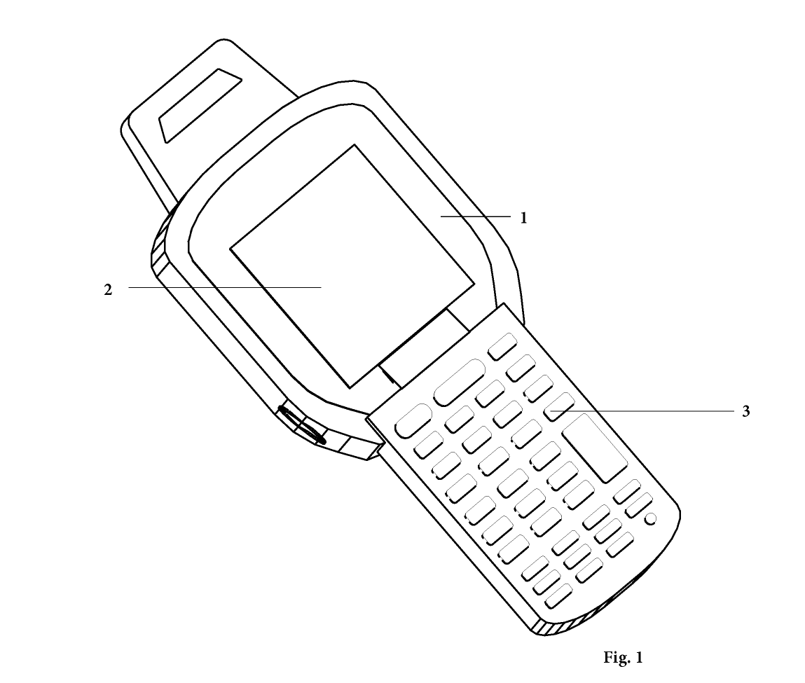

With reference now to the drawings, and in particular to FIG. 1 thereof, a new and improved GPS scanner device embodying the principles and concepts of the present invention is described herein.

Referring to FIG. 1, an embodiment of the GPS scanner device according to this invention is designated generally by the reference character 1. The overall assembly of the scanner device includes the scanner, which scans the packages going out for delivery, attached therewith is a GPS, which gives the deliverer (or driver) a map to reach the various locations (addresses of the deliverables). The map can be clearly viewed on the screen 2 that is provided at the upper half of the scanner device. The bottom half of the scanner device is provided with the keyboard 3, to key in anything that needs to be keyed in.

In accordance with the invention, a light-weight, hand held GPS scanner device is disclosed that can be rugged, durable, and waterproof; built to withstand any extreme environmental conditions. Backlighted scans and sensors are provided to detect light exposure.

The device is operable by solar powered rechargeable batteries as well as power cords, such as car chargers and electric wall chargers.

A further embodiment discloses the GPS enabled package delivery system associated with a mobile application, which can be easily installed in smart phones, tablets, and other like devices. The application is utilized to track the location of the packages and estimated time of delivery.

Accordingly, in some other embodiment, this would reduce the cost to the shipper through the improved delivery density and a reduction in aborted delivery attempts, a significant benefit since it is estimated that a large percentage of households have no one home during the day. Thus, the GPS enabled system is capable of using available real time information and adapting/revising the planned delivery route in a way that human planners cannot do.

As may now be appreciated from the above description and reference to the accompanying drawings, the present invention provides a GPS enabled package delivery system that is equipped with a GPS Scanner device and an associated mobile application. The invention may be utilized by delivery companies and their representatives (deliverers) to deliver packages, and by the end user (customer or a package receiver) to track the location of the packages to be delivered, thereby ensuring on time delivery with a satisfactorily result.

While illustrative embodiments of the Invention have been described herein, the present invention is not limited to the various preferred embodiments described herein, but includes any and all embodiments having equivalent elements, modifications, omissions, combinations (e.g., of aspects across various embodiments), adaptations, and/or alterations as would be appreciated by those in the art based on the present disclosure. For example, the preferred embodiment was described as including many sources of information to calculate an optimum route. However, many of these sources of information may be replaced or eliminated, or may come from other sources than those described herein. This may depend on a cost-benefit analysis to the user. Also, while this invention has particular applicability to service vehicles, the invention may also be used in a non-commercial setting. As an additional example, many of the functions described may occur in separate stand-alone systems and be communicatively coupled with the systems (e.g., the GPS system and navigation systems in the delivery van may be separate stand-alone systems from the GPS enabled system, and may be part of it).

It is to be understood that the above description is intended to be illustrative, and not restrictive. For example, the above-discussed embodiments may be used in combination with each other. Many other embodiments will be apparent to those of skill in the art upon reviewing the above description. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A GPS enabled package delivery system capable of providing an optimum route planning for a deliverer to deliver the packages, comprising:
GPS scanner device to scan the packages going out for deliver;
GPS enabled system to provide an optimum route to the deliverer and having access to destination information of multiple destinations to which the deliverer is to travel and road map information, calculating an initial optimum route the deliverer is to travel, including determining an order of the multiple destinations to which the deliverer is to travel; and
a communication system receiving updated information and thereby communicating the same to the deliverer;

2. The GPS enabled package delivery system of claim 1 wherein said system calculates again an optimum route based on the destination information, the road map information and the updated information upon receiving of the updated information.

3. A GPS enabled package delivery system of claim 1, wherein said GPS scanner and provided system gives the route, distance and time of delivery to each package.

4. A GPS enabled package delivery system of claim 1, wherein said GPS scanner device serves to be a navigation device.

5. A GPS enabled package delivery system of claim 4, wherein the navigation system will guide the deliverer with driving directions enabling him to deliver packages one by one in a sequential manner.

6. A GPS enabled package delivery system of claim 1, wherein the scanner device further comprising a screen at the upper half to view the map in easily readable manner to locate the addresses of the deliveries and a keyboard at the bottom half to key in anything that needs to be keyed in.

7. A GPS enabled package delivery system of claim 1, wherein the updated information is updated destination information modifying destinations to which the deliverer is to travel.

8. A GPS enabled package delivery system of claim 1, wherein the updated destination information includes a new destination for a product delivery.

9. A GPS enabled package delivery system of claim 1, wherein the updated information is traffic congestion information.

10. A GPS enabled package delivery system of claim 1, wherein the updated information is addressee location information indicating a location of an addressee of a deliverable.

11. A GPS enabled package delivery system of claim 1, wherein said system determines whether or not the addressee location information corresponds to a desired destination of the multiple destinations, and determines whether or not the destination information should be modified and a new optimum route calculated.

12. A GPS enabled package delivery system of claim 1, wherein the calculation disregards destinations of the multiple destinations the deliverer has already visited.

13. A GPS enabled package delivery system of claim 1, wherein said GPS scanner is a hand-held, light weight and easy to use device; which also integrates other technologies such as google maps, WAZE, google search, etc.

14. A GPS enabled package delivery system of claim 1, wherein said system integrates the downloadable mobile application for smart phones and related devices to track the location of the packages by the customers.

15. A GPS enabled package delivery system of claim 1 ensures the on time delivery and reduce the cost to the shipper through the improved delivery density and a reduction in aborted delivery attempts.
